(19) United States
(12) Patent Application Publication
(10) Pub. No.: US 2009/0226242 A1
(43) Pub. Date: Sep. 10, 2009

(54) WASTE RECEPTACLE COUPLING DEVICE

(76) Inventor: Charles E. Larman, Carmel, IN (US)

Correspondence Address: KRIEG DEVAULT LLP, ONE INDIANA SQUARE, SUITE 2800, INDIANAPOLIS, IN, 46204-2079, US

(21) Appl. No.: 12/043,998

(22) Filed: Mar. 7, 2008

(51) Int. Cl. F16B 1/00

(52) U.S. Cl. 403/24; 403/33; 403/404

(57) ABSTRACT

An apparatus for transporting at least one waste receptacle. In at least one embodiment of the present disclosure, the apparatus comprises a block having a first block surface and a second block surface opposite the first block surface, at least one first prong projecting from the first block surface, at least one second prong projecting from the second block surface, and a retaining bar projecting from the first block surface, wherein the at least one first prong is approximately parallel to the at least one second prong.

### BACKGROUND

Transport of waste from a place of residence or business to a collection site can be a cumbersome process, which often involves the use of mobile waste receptacles. While these receptacles are able to transport a large volume of waste, there is often a need, due to waste volume or the rate of waste collection, for multiple receptacles. One of the intrinsic properties of these receptacles is that their large size and shape precludes many individuals from comfortably transporting more than a single receptacle at one time. Given the time lost performing multiple trips to the waste collection site, there is an clear need for a device which would enable an individual to transport more than one mobile waste receptacle at a time.

### SUMMARY

The present disclosure of the application includes the disclosure of apparatuses for the transport of at least one waste receptacle. According to at least one embodiment of an apparatus for the transport of at least one waste receptacle of the present disclosure, the apparatus comprises a block having a first block surface and a second block surface opposite the first block surface, at least one first prong projecting from the first block surface, at least one second prong projecting from the second block surface, and a retaining bar projecting from the first block surface, wherein the at least one first prong is approximately parallel to the at least one second prong.

According to an aspect of at least one embodiment of an apparatus for transporting at least one waste receptacle of the present disclosure, the apparatus comprises a block having a first block surface and a second block surface opposite the first block surface; a first prong having a first prong surface, the first prong surface of the first prong coupled to the first block surface of the block; a second prong having a second prong surface, the second prong surface of the second prong coupled to the second block surface of the block; and a retaining bar coupled to the first block surface of the block, the retaining bar sized to engage a portion of a first waste receptacle.

According to an aspect of at least one embodiment of an apparatus for transporting at least one waste receptacle of the present disclosure, the at least one first prong is sized to engage a recessed area of a first waste receptacle.

According to an aspect of at least one embodiment of an apparatus for transporting at least one waste receptacle of the present disclosure, the at least one second prong is sized to engage a handle area of a second waste receptacle.

According to an aspect of at least one embodiment of an apparatus for transporting at least one waste receptacle of the present disclosure, whereby two waste receptacles may be detachably joined to the apparatus by engaging the at least one first prong with a recessed area of a first waste receptacle and the at least one second prong with a handle area of a second waste receptacle.

According to an aspect of at least one embodiment of an apparatus for transporting at least one waste receptacle of the present disclosure, the apparatus, or the block of the apparatus, is comprised of a rigid material, such as, for example, a metal, a plastic, a composite material, or a carbon fiber material.

According to an aspect of at least one embodiment of an apparatus for transporting at least one waste receptacle of the present disclosure, the first prong and second prong are positioned approximately parallel to each other.

According to an aspect of at least one embodiment of an apparatus for transporting at least one waste receptacle of the present disclosure, the first prong, and/or the second prong, is/are adjustable relative to the block.

According to an aspect of at least one embodiment of an apparatus for transporting at least one waste receptacle of the present disclosure, the apparatus further comprises a third prong having a third prong surface, the third prong surface coupled to the first block surface of the block.

According to an aspect of at least one embodiment of an apparatus for transporting at least one waste receptacle of the present disclosure, the apparatus further comprises a fourth prong having a fourth prong surface, the fourth prong surface coupled to the second block surface of the block.

### BRIEF DESCRIPTION OF DRAWINGS

The features and advantages of this disclosure, and the manner of attaining them, will be more apparent and better understood by reference to the following descriptions of embodiments of the disclosure, taken in conjunction with the accompanying drawings, wherein:

FIG. 1A is a rear view of a waste receptacle coupling device according to an embodiment of the present disclosure;

FIG. 1B is a front view of a waste receptacle coupling device according to an embodiment of the present disclosure;

FIG. 2 is a side view of a waste receptacle coupling device according to an embodiment of the present disclosure;

FIG. 3 is a side perspective view of a waste receptacle coupling device according to an embodiment of the present disclosure;

FIG. 4 is a side perspective view of a waste receptacle coupling device according to an embodiment of the present disclosure;

FIG. 5 is a bottom perspective view of a waste receptacle coupling device according to an embodiment of the present disclosure;

FIG. 6 is a side view of a waste receptacle coupling device coupled to a waste receptacle according to an embodiment of the present disclosure;

FIG. 7 is a side view of a waste receptacle coupling device coupled to one receptacle and positioned for coupling to a second receptacle according to an embodiment of the present disclosure;

FIG. 8 is a top view of a waste receptacle coupling device installed between two waste receptacles according to an embodiment of the present disclosure;

FIG. 9 is a side view of a waste receptacle coupling device coupled to two receptacles according to an embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

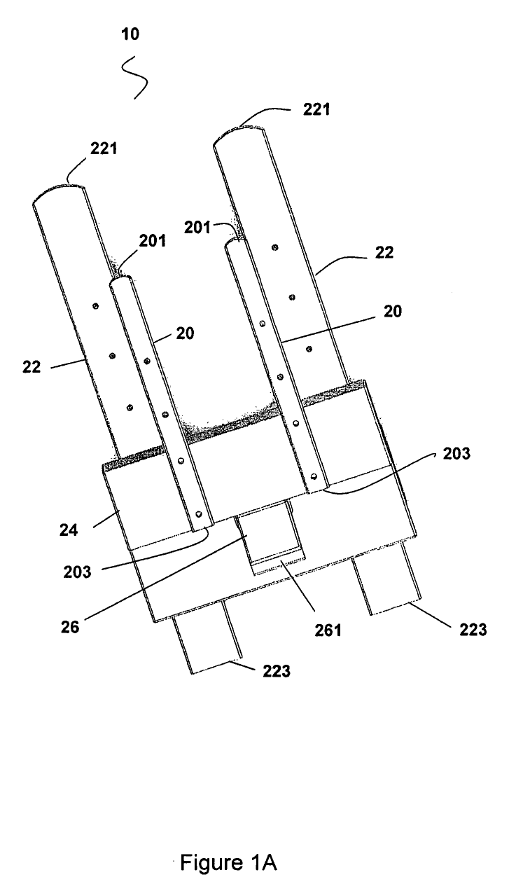

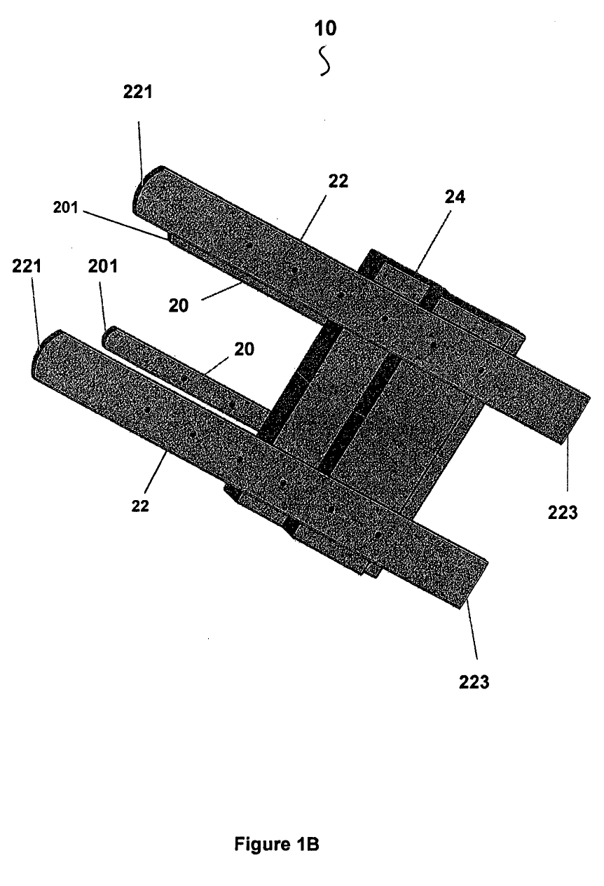

Turning to FIGS. 1A and 1B, there are shown rear and front views, respectively, of waste receptacle coupling device 10 according to at least one embodiment of the present disclosure. As shown in FIGS. 1A and 1B, waste receptacle coupling device 10 comprises a pair of rear prongs 20, a pair of front prongs 22, a block 24 interposed between rear prongs 20 and front prongs 22, and a retaining bar 26 extending from block 24. In at least one embodiment of the present disclosure, the elements of waste receptacle coupling device 10 may be comprised of any resilient, rigid material such as, for example, plastic, fiberglass, wood, metal, a carbon fiber material, or a composite of several materials.

In at least one embodiment of the present disclosure, each rear prong 20 comprises an elongated shape and includes top end 201 and bottom end 203. In at least one embodiment of the present disclosure, each front prong 22 comprises an elongated shape and includes top end 221 and bottom end 223. In at least one embodiment of the present disclosure, retaining bar 26 comprises an elongated shape and includes end 261.

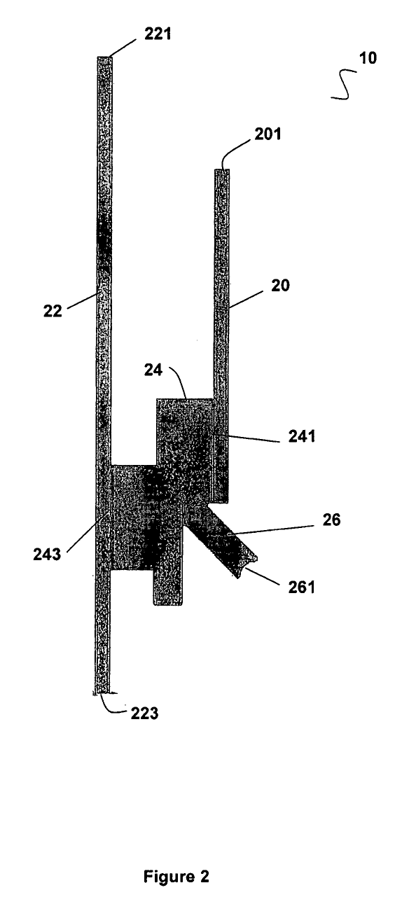

Turning now to FIG. 2, there is shown a side view of waste receptacle coupling device 10 according to at least one embodiment of the present disclosure. Shown in FIG. 2 are rear prong 20, front prong 22, block 24 interposed between rear prong 20 and front prong 22, and retaining bar 26 extending from block 24. Also shown in FIG. 2 are first block surface 241 and second block surface 243. In the embodiment of waste receptacle coupling device 10 depicted in FIG. 2, rear prong 20 may be detachably connected to block 24 at first block surface 241. For example, rear prong 20 may be detachably connected to block 24 at first block surface 241 through the use of thumb screws, clamps, Velcro®, magnetic force, adhesives, or other fastening methods (not shown in FIG. 2). In such an embodiment of the present disclosure, rear prong 20 may be detached from block 24 and repositioned so that the position of top end 201 relative to block 24 may be adjusted. After rear prong 20 is repositioned adjacent to first block surface 241 with top end 201 and block 24 in the desired relationship, rear prong 20 may be reattached to block 24. In at least one embodiment of the present disclosure, rear prong 20 is not detachable from block 24. In at least one embodiment of the present disclosure, rear prong 20 is formed out of block 24 such that rear prong 20 and block 24 are of a unitary construction.

Likewise, in the embodiment of waste receptacle coupling device 10 depicted in FIG. 2, front prong 22 may be detachably connected to block 24 at second block surface 243. For example, front prong 22 may be detachably connected to block 24 at second block surface 243 through the use of thumb screws, clamps, Velcro®, magnetic force, adhesives, or other fastening methods (not shown in FIG. 2). In such an embodiment of the present disclosure, front prong 22 may be detached from block 24 and repositioned so that the position of top end 221 relative to block 24 may be adjusted. After front prong 22 is repositioned adjacent to first block surface 243 with top end 221 and block 24 in the desired relationship, front prong 22 may be reattached to block 24. In at least one embodiment of the present disclosure, front prong 22 is not detachable from block 24. In at least one embodiment of the present disclosure, front prong 22 is formed out of block 24 such that front prong 22 and block 24 are of a unitary construction.

In at least one embodiment of the present disclosure, one end of retaining bar 26 is connected to block 24, and end 261 of retaining bar 26 extends away from block 24. In the embodiment shown in FIG. 2, retaining bar 26 extends away from block 24 at approximately a 45° angle, but this is not required. The angle between retaining bar 26 and block 24 may be more than or less than 45°. In at least one embodiment of the present disclosure, retaining bar 26 is formed out of block 24 such that retaining bar 26 and block 24 are of a unitary construction. In the embodiments of waste receptacle coupling device 10 according to the present disclosure shown in FIGS. 1A, 1B, and 2, end 261 of retaining bar 26 comprises a concave shape, but this is not required.

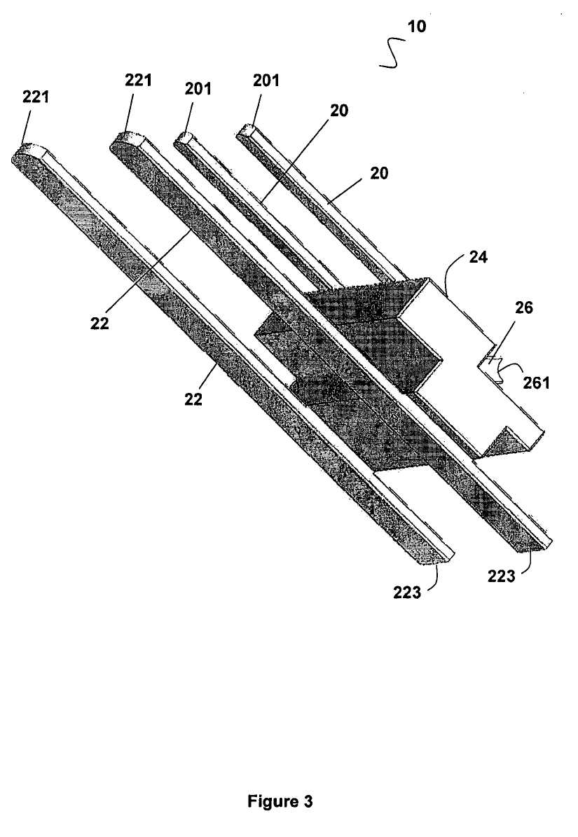

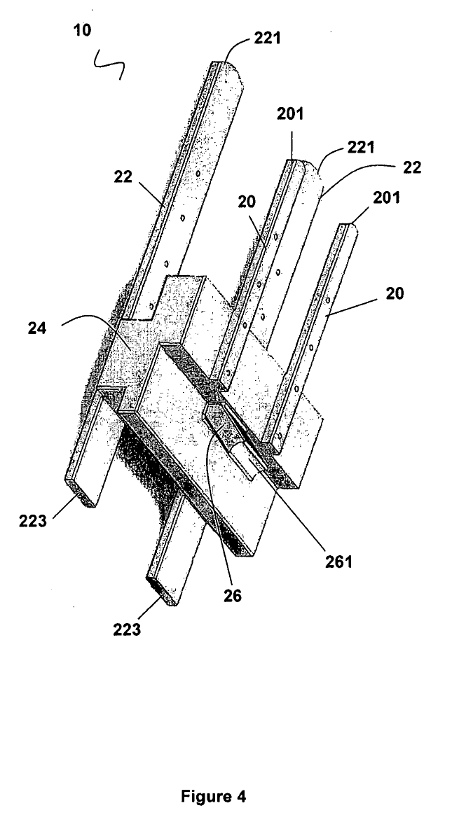

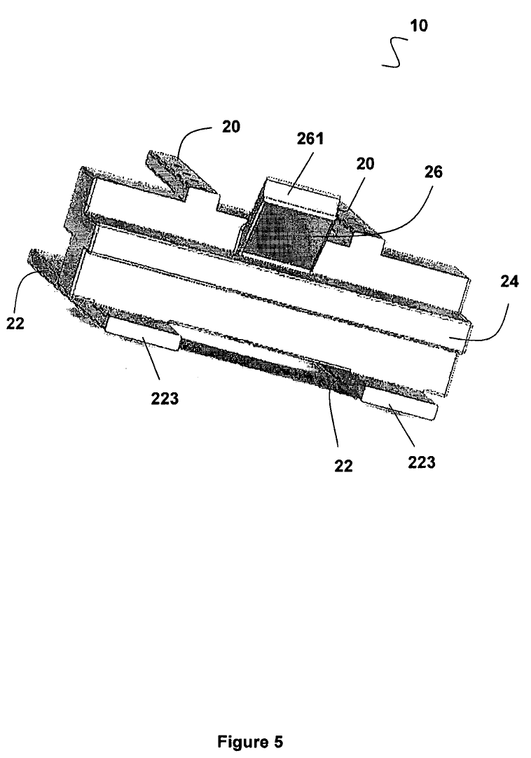

Turning now to FIGS. 3-5, there is shown a waste receptacle coupling device 10 according to at least one embodiment of the present disclosure in front perspective view, rear perspective view, and bottom perspective view, respectively.

Although FIGS. 1-5 show embodiments of the present disclosure comprising two front prongs 20, two rear prongs 22, and one retaining bar 26, other configurations are within the scope of the present disclosure. A waste receptacle coupling device 10 according to the present disclosure may comprise one or more front prongs 20 and one or more rear prongs 22 and one or more retaining bars 26.

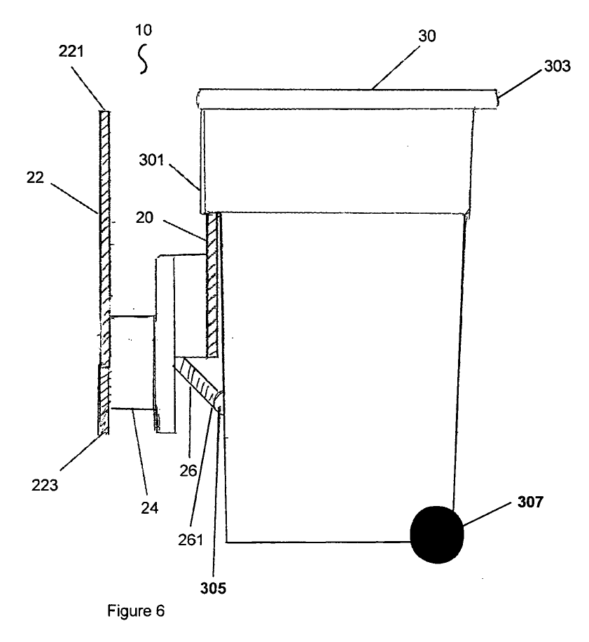

Turning now to FIG. 6, there is shown a side view of a waste receptacle coupling device 10 according to at least one embodiment of the present disclosure operably connected to a first waste receptacle 30. In the embodiment shown in FIG. 6, waste receptacle 30 comprises a recessed area 301, handle area 303, contact point 305, and one or more rear wheels 307 (only one of which is shown in FIG. 6). In at least one embodiment of waste receptacle 30, contact point 305 comprises a cylindrical crossbar installed substantially parallel to the ground. In at least one embodiment of waste receptacle 30, recessed area 301 and contact point 305 are arranged and constructed in such a way as to accommodate lifter units on automated refuse collection vehicles.

As shown in FIG. 6, waste receptacle coupling device 10 according to at least one embodiment of the present disclosure is operably connected to first waste receptacle 30 by inserting top end 201 (not shown) of rear prong 20 into recessed area 301 of waste receptacle 30, and placing end 261 of retaining bar 26 in contact with contact point 305. Where contact point 305 comprises a cylindrical crossbar installed substantially parallel to the ground, end 261 of retaining bar 26 may comprise a concave shape that mates with the cylindrical shape of contact point 305.

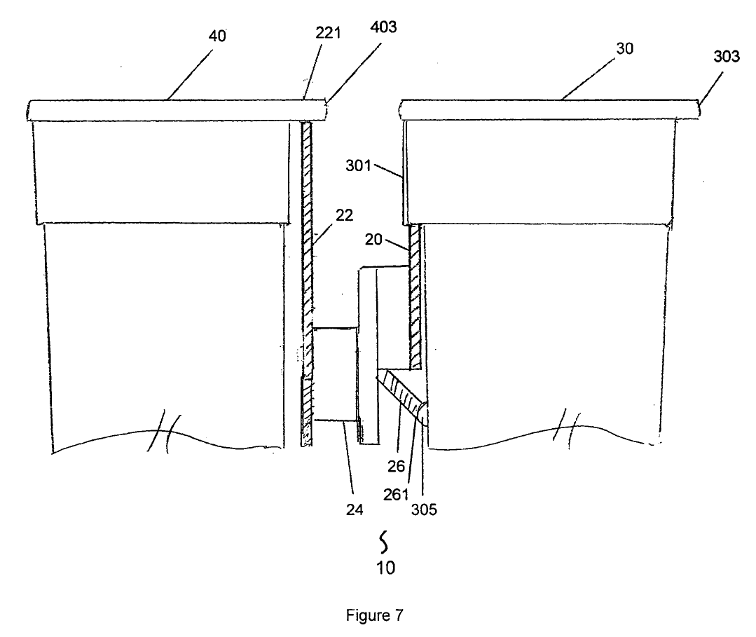

Turning now to FIG. 7, there is shown a side view of a waste receptacle coupling device 10 according to at least one embodiment of the present disclosure operably connected to a first waste receptacle 30 and a second waste receptacle 40. As shown in FIG. 7, waste receptacle coupling device 10 is operably connected to first waste receptacle 30 by inserting top end 201 (not shown) of rear prong 20 into recessed area 301 of waste receptacle 30, and placing end 261 of retaining bar 26 in contact with contact point 305. As shown in FIG. 7, waste receptacle coupling device 10 is operably connected to second waste receptacle 40 by inserting top end 221 of front prong 22 into an aperture in handle area 403 of second waste receptacle 40.

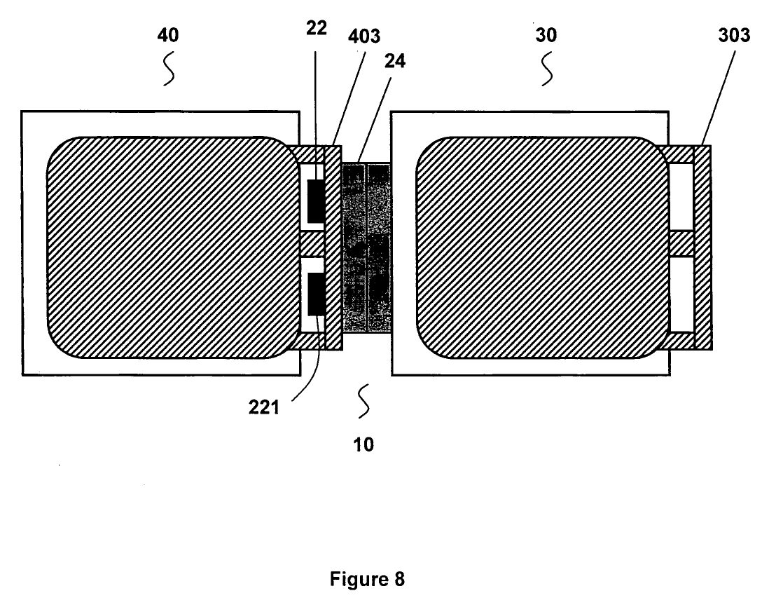

Turning now to FIG. 8, there is shown a top view of a waste receptacle coupling device 10 according to at least one embodiment of the present disclosure operably connected to a first waste receptacle 30 and a second waste receptacle 40. As shown in FIG. 8, each top end 221 of each front prong 22 of waste receptacle coupling device 10 is inserted into an aperture in handle area 403 of second waste receptacle 40.

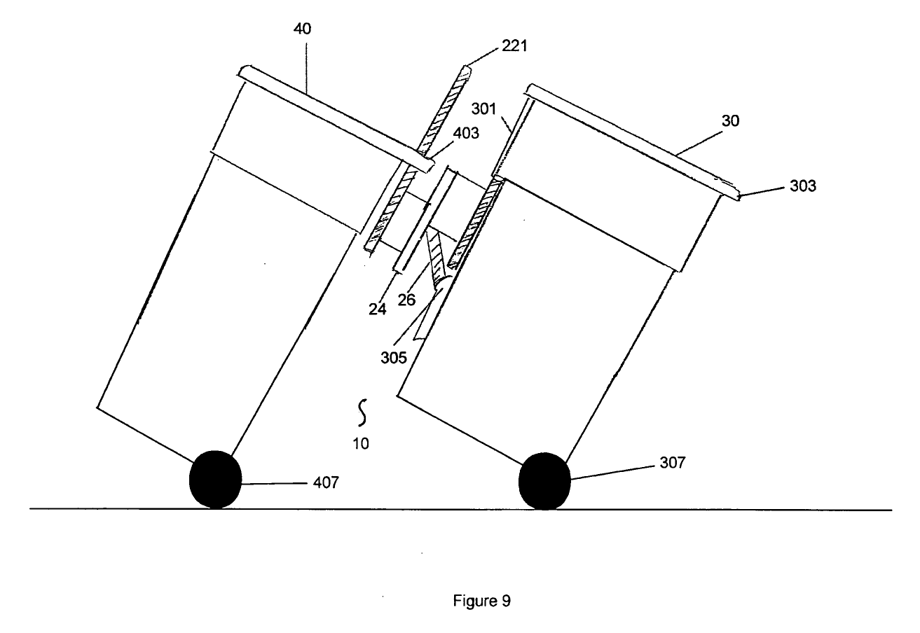

Turning now to FIG. 9, there is shown a side view of a waste receptacle coupling device 10 according to at least one embodiment of the present disclosure operably connected to a first waste receptacle 30 and a second waste receptacle 40. As shown in FIG. 9, by exerting a force on handle 303, first waste receptacle 30 is caused to rotate about the axle of wheels 307. As illustrated in FIG. 9, in this embodiment of the present disclosure, rotation of first waste receptacle 30 about the axle of wheels 307 causes first waste receptacle 30 to tip, thereby causing waste receptacle coupling device 10 to move upward. Front prong 22 is forced upwardly through the aperture in handle area 403 of second waste receptacle 40, causing second waste receptacle 40 to rotate about the axle of wheels 407. Only wheels 307 and 407 of first waste receptacle 30 and second waste receptacle 40, respectively, remain in contact with the ground. First waste receptacle 30 and second waste receptacle 40 thereby are placed into a position to be readily moved by pushing or pulling on handle area 303.

To accommodate waste receptacles of varying sizes and shapes and configurations, the arrangement of components of waste receptacle coupling device 10 of the present disclosure may be adjusted accordingly. In at least one embodiment of the present disclosure, rear prong 20 and front prong 22 may be structured and attached in such a way as to be movable relative to block 24. In at least one embodiment of the present disclosure, the distance between rear prong 20 and front prong 22 may adjustable by adjusting the size of block 24. In at least one embodiment, rear prong 20 and front prong 22 may have at least one hole through the prong. Such a hole may be used for attachment of the front prong or rear prong to block 24. In at least one embodiment of the present disclosure, rear prong 20 and front prong 22 may be positioned approximately parallel to each other, but this is not required. In at least one embodiment of the present disclosure, rear prong 20 and front prong 22 may be adjustable vertically relative to block 24. For example, in at least one embodiment of the present disclosure the length of either or both of rear prong 20 and/or front prong 22 may be adjusted by a telescoping method.

In at least one embodiment of the present disclosure, retaining bar 26 may be modified for transportation or adaptability. In at least one embodiment the present disclosure, retaining bar 26 may have a portions defining a hole that may be useful for grasping.

At least one embodiment of the present disclosure comprises a waste transportation system wherein waste receptacle coupling device 10 is integrated into a surface of a waste receptacle, such as, for example waste receptacle 30. In such an embodiment, waste receptacle coupling device 10 is not detachable from the surface of the waste receptacle.

In at least one embodiment of the present disclosure, a method of coupling one or more waste receptacles is described which includes the steps of: placing a waste receptacle comprising a recessed area, a contact point (such as, for example, a cylindrical crossbar installed substantially parallel to the ground), and a plurality of wheels upright on a surface; positioning a waste receptacle coupling device comprising a first prong, a second prong, a block and a retaining bar such that the first prong is engageably connected to the recessed area of the waste receptacle; positioning the retaining bar against the retaining wall of the waste receptacle; and positioning the waste receptacle relative to the surface such that the weight of the waste receptacle resides substantially over the plurality of wheels.

Throughout the specification, unless the context requires otherwise, the words “comprise” and “include” and variations such as “comprising” and “including” will be understood to imply the inclusion of an item or group of items, but not the exclusion of any other item or group items.

While this disclosure has been described as having preferred designs, the apparatus and methods according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

I claim:

1. An apparatus for transporting at least one waste receptacle, said apparatus comprising:
a block having a first block surface and a second block surface opposite said first block surface, at least one first prong projecting from said first block surface, at least one second prong projecting from said second block surface, and a retaining bar projecting from said first block surface, wherein said at least one first prong is approximately parallel to said at least one second prong.

2. The apparatus of claim 1, wherein said at least one first prong is sized to engage a recessed area of a first waste receptacle.

3. The apparatus of claim 1, wherein said at least one second prong is sized to engage a handle area of a second waste receptacle.

4. The apparatus of claim 1, whereby two waste receptacles may be detachably joined by engaging said at least one first prong with a recessed area of a first waste receptacle and said at least one second prong with a handle area of a second waste receptacle.

5. The apparatus of claim 1, wherein said block is comprised of a metal.

6. The apparatus of claim 1, wherein said block is comprised of a plastic.

7. The apparatus of claim 1, wherein said block is comprised of a composite material.

8. The apparatus of claim 1, wherein said block is comprised of a carbon fiber material.

9. An apparatus for transporting at least one waste receptacle, said apparatus comprising:
a block having a first block surface and a second block surface opposite said first block surface;
a first prong having a first prong surface, said first prong surface of said first prong coupled to said first block surface of said block;
a second prong having a second prong surface, said second prong surface of said second prong coupled to said second block surface of said block; and
a retaining bar coupled to said first block surface of said block, said retaining bar sized to engage a portion of a first waste receptacle.

10. The apparatus of claim 9, wherein said first prong is sized to engage a recessed area of said first waste receptacle.

11. The apparatus of claim 9, wherein said second prong is sized to engage a handle portion of a second waste receptacle.

12. The apparatus of claim 9, whereby two waste receptacles may be detachably joined by engaging said first prong with a recessed area of a first waste receptacle and said second prong with a handle area of a second waste receptacle.

13. The apparatus of claim 9, wherein said first prong and second prong are positioned approximately parallel to each other.

14. The apparatus of claim 9, wherein at least one of said block, said first prong, said second prong, and said retaining bar is comprised of a metal.

15. The apparatus of claim 9, wherein at least one of said block, said first prong, said second prong, and said retaining bar is comprised of a plastic.

16. The apparatus of claim 9, wherein at least one of said block, said first prong, said second prong, and said retaining bar is comprised of a composite material.

17. The apparatus of claim 9, wherein at least one of said block, said first prong, said second prong, and said retaining bar is comprised of a carbon fiber material.

18. The apparatus of claim 9, wherein said first prong is adjustable relative to said block.

19. The apparatus of claim 9, wherein said second prong is adjustable relative to said block.

20. The apparatus of claim 9, further comprising a third prong having a third prong surface, said third prong surface coupled to said first block surface of said block.
